(19) United States
(12) Patent Application Publication
(10) Pub. No.: US 2003/0211883 A1
(43) Pub. Date: Nov. 13, 2003

(54) System and method for performing a financial transaction within a casino

(75) Inventor: Craig K. Potts, Prior Lake, MN (US)

Correspondence Address: Timothy A. Czaja, Dicke, Billing & Czaja, PLLC, Fifth Street Towers, 100 South Fifth Street, Suite 2250, Minneapolis, MN, 55402, US

(73) Assignee: Cash Systems, Inc.

(21) Appl. No.: 10/417,639

(22) Filed: Apr. 17, 2003

Related U.S. Application Data
(60) Provisional application No. 60/378,306, filed on May 7, 2002.

(51) Int. Cl. A63F 13/00

(52) U.S. Cl. 463/25

(57) ABSTRACT

A method of performing a financial transaction by a casino customer located at a casino gaming station. The method includes providing a portable, remote control unit (RCU) to the customer at the gaming station. Transaction information is entered into the RCU relating to a desired financial transaction. The transaction information is signaled from the RCU to a base processor via a wireless transmission. The RCU is operated to electronically capture a signature of the customer, with this electronically captured signature being signaled from the RCU to the base processor via a wireless transmission. Finally, the base processor is operated to print, via a printer electronically connected to the base processor, a negotiable financial document based upon the transaction information. The printed negotiable financial document includes the customer's signature, generated by the base processor based upon the electronically captured signature.

### CROSS-REFERENCE TO RELATED APPLICATIONS

This application claims priority to U.S. Provisional Patent Application Serial No. 60/378,306, entitled “System and Method for Performing a Financial Transaction within a Casino” filed on May 7, 2002.

### BACKGROUND OF THE INVENTION

The present invention relates to a system and method for facilitating a convenient, on-demand financial card transaction by a casino patron. More particularly, it relates to a system and method for providing a casino customer, otherwise located at a gaming station (e.g., gaming machine or table), the ability to quickly obtain cash, chips, etc., via a financial card transaction without requiring the customer to leave the gaming station.

A number of aspects related to casino gaming and operation are becoming increasingly sophisticated. Casino patrons enjoy playing the plethora of unique video slot, poker, and other electronic games of chance. Other technological advancements, such as card shuffling machines, chip handling devices, etc., enhance the customer's perception of casino security and fairness. Each of these factors contribute to a heightened desire to visit and participate in gaming activities at a particular casino, a result clearly desired by casino operators.

One aspect of the casino gaming experience that has, however, remained essentially unchanged is the method by which casino customers are able to access off-site financial accounts and obtain currency for use in the casino. Typically, a customer brings currency with him/her to the casino that can be exchanged for negotiable items (e.g., chips or casino-issued gaming cards) and/or used with various gaming machines. Invariably, a customer may forget to bring a desired amount of currency with him/her to the casino, and/or depletes the supply of currency brought to the casino before he/she is ready for their gaming experience to end. Under these circumstances, the customer will desire to access additional monies otherwise available through one or more financial institutions at which the customer maintains an account. For example, the customer can utilize an automatic teller machine (“ATM”), cash a check, receive a cash advance from a credit card account, etc.

The ability to obtain funds within a casino from a variety of different resources is clearly appealing to patrons and the casino itself. Regardless of the particular technique, however, certain drawbacks remain. In particular, casino customers are presently unable to perform a monetary advance transaction directly from the gaming station at which the customer is located. Instead, the casino customer is required to walk away from the gaming activity in which he/she is engaged, locate an appropriate transaction machine/station, and perform the desired financial transaction. For example, while convenient, ATMs are typically dispersed at various locations within the casino, away from individual gaming stations. Alternatively, a credit card-type transaction can be performed through a casino teller (or other designated individual) otherwise residing at a central “cage” station. Even further, while cash advance kiosks have recently become highly popular and present certain conveniences to customers, the customer is still required to leave the gaming station to perform the desired financial transaction.

Casino customers can be frustrated when having to leave a gaming station to perform a monetary advance transaction. A popular gaming strategy is to continue playing a particular gaming activity after successive losses based upon a belief that the customer is “due” to win in the near future. For example, slot machine players often enjoy remaining at a particular slot machine for an extended length of time, theorizing that the slot machine will produce a large jackpot after a certain number of plays. Similarly, black jack, roulette, craps, etc., players often desire to stay at a particular gaming table to “ride out” a losing streak, assuming that one or more winning wagers are soon to occur. Being forced to leave the gaming station to obtain additional funds undermines this gaming strategy, and is thus disconcerting to the casino customer. The casino also has a vested interest in not only keeping customers happy, but also encouraging customers to continue playing at a particular gaming station.

Casino customers can access outside financial accounts to obtain money at a casino in a variety of fashions. However, all existing techniques require the customer to stop a particular gaming activity, and leave the gaming station at which the customer is located. This requirement is undesirable to both the customer and the casino. Therefore, a need exists for a system and method of performing a financial transaction at a gaming station in a manner that satisfies prescribed security regimens.

### SUMMARY OF THE INVENTION

One aspect of the present invention relates to a method of performing a financial transaction within a casino, and in particular by a casino customer located at a casino gaming station. The method includes providing a portable, remote control unit (RCU) to the casino customer at the casino gaming station. Transaction information is entered into the RCU relating to a financial transaction desired by the casino customer from an account owned by the customer. The transaction information is signaled from the RCU to a base processor via a wireless transmission. The RCU is operated to electronically capture a signature of the casino customer, with this electronically captured signature being signaled from the RCU to the base processor via a wireless transmission. Finally, the base processor is operated to print, via a printer electronically connected to the base processor, a negotiable financial document based upon the transaction information. In this regard, the printed negotiable financial document includes the customer's signature, generated by the base processor based upon the electronically captured signature. In one preferred embodiment, the RCU designates to the base processor a location of the gaming station, and a negotiable instrument is delivered to the casino customer following printing of the negotiable financial document based upon the designated gaming station location. In this regard, and in yet another preferred embodiment, the delivered negotiable instrument includes at least one of cash, casino-issued chips, casino-issued gaming card, a check, or the printed negotiable financial document.

Another aspect of the present invention relates to a system for performing a financial transaction within a casino by a casino customer located at a casino gaming station. The system includes a remote control unit (RCU), a base processor, and a printer. The RCU is deliverable to the gaming station, and is adapted to receive transaction information relating to a financial transaction desired by the casino customer from an account owned by the customer. Further, the RCU is adapted to electronically capture a signature of the casino customer, and wirelessly signal the transaction information and the electronically captured signature. The base processor is adapted to receive wireless signals from the RCU and generate negotiable financial document formatting information based upon the transaction information and the electronically captured signature. Finally, the printer is electronically connected to the base processor. The printer utilizes the negotiable financial document formatting information to print a negotiable financial document that includes the customer's signature. With this system, a casino customer can perform a desired financial transaction without leaving the gaming station at which he or she is participating in a gaming activity.

### BRIEF DESCRIPTION OF THE DRAWINGS

FIG. 1 is a block diagram of a casino transaction system in accordance with an embodiment of the present invention;

FIG. 2A is a simplified plan view of an embodiment of a portable remote control unit useful with the system of FIG. 1;

FIG. 2B is a block diagram of the portable remote control unit of FIG. 2A;

FIG. 3 is a simplified plan view of a base processor useful with the system of FIG. 1; and

FIGS. 4A-4B is a flow diagram, illustrating one embodiment of a method of performing a casino financial transaction in accordance with the present invention.

### DETAILED DESCRIPTION OF THE PREFERRED EMBODIMENTS

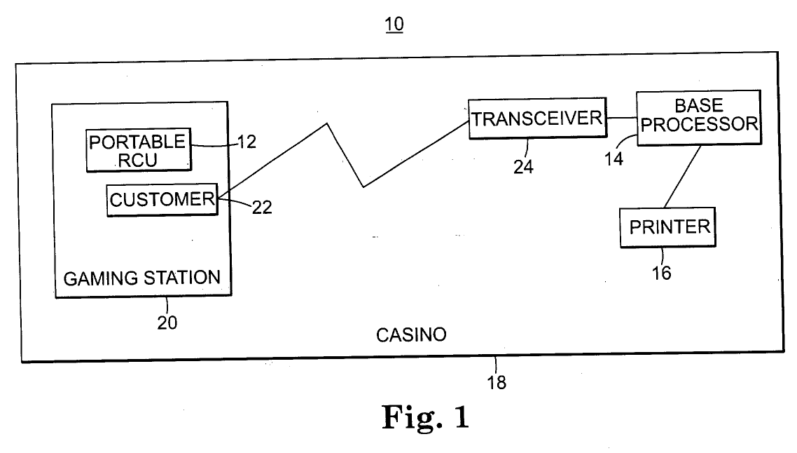

One embodiment of a casino financial transaction system 10 in accordance with the present invention is shown in block form in FIG. 1. The system 10 includes a portable remote control unit (RCU) 12, a base processor module 14, and a printer 16. The components are described in greater detail below. In general terms, however, the system 10 is adapted for use within a casino 18 having at least one gaming station 20. The gaming station 20 can assume a wide variety of forms, including, for example, a gaming machine (e.g., slot machine, video poker, keno terminal, etc.) or a gaming table (e.g., black jack, poker, craps, roulette, etc.). Regardless, the RCU 12 is adapted to facilitate a financial card-type transaction (e.g., credit card, bank card, debit card, etc.), and is presented to a customer 22 otherwise located at the gaming station 20. Information relating to the desired financial transaction is entered into the RCU 12, that in turn signals the information to the base processor module 14 via wireless transmission. In one preferred embodiment, a terminal transceiver (not shown) is provided for receiving the wireless transmission. The base processor module 14, in turn, is operated to obtain approval for the desired financial transaction. Upon receiving approval for the desired transaction, the customer 22 enters his/her signature into the RCU 12 that in turn forwards an electronic copy of the customer's signature to the base processor module 14. The base processor module 14 then operates the printer 16 to print a negotiable financial document that includes the customer's signature. Finally, a financial instrument (e.g., chips, cash, check, etc.) is presented to the customer 22 at the gaming station 20. Thus, the entire financial transaction occurs without the customer 22 ever leaving the gaming station 20.

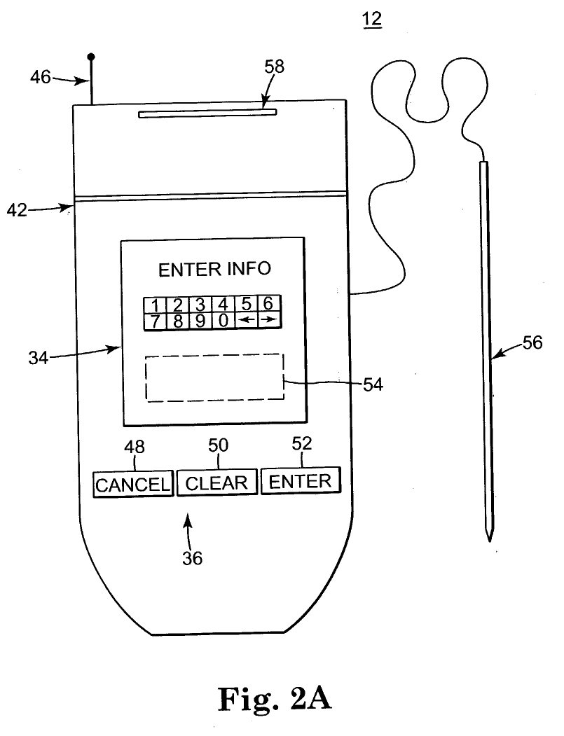

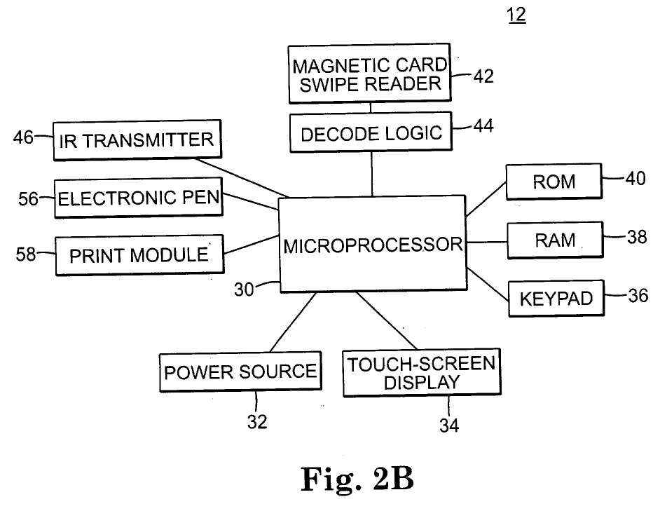

One preferred embodiment of the portable RCU 12 is shown in greater detail in FIGS. 2A and 2B. As a point of reference, FIG. 2A provides a top plan view of the RCU 12, whereas the internal components are shown in block form in FIG. 2B. With this in mind, the RCU 12 preferably includes a microprocessor 30, a power source 32, a touch-screen display 34, a keypad 36, RAM 38, ROM 40, a magnetic card swipe reader 42, a decode logic module 44, and an IR transmitter 46. Construction and connection of the various components 30-46 are known in the art, and their interrelationship is described as follows.

The power source 32 is adapted to supply requisite power to other components of the portable RCU 12 (e.g., the microprocessor), and renders the RCU 12 truly portable. Thus, in one preferred embodiment, the power source 12 is a battery, although other types of self-contained power supply devices are acceptable. Alternatively, the RCU 12 can be adapted to be powered by a separate power supply provided within the casino 18 (FIG. 1).

The touch-screen display 34 and the keypad 36 provide a means for interaction between the customer 22 (FIG. 1) and the RCU 12. For example, the touch-screen display 34 can be operated to display various instructions and selection options to the customer 22 related to a desired financial transaction, with the displayed information/selections changing throughout a transaction operation. The keypad 36 preferably presents “standard” selection options to the customer 22, such as a “cancel” key 48, a “clear” key 50, and a “enter” key 52. The microprocessor 30 is adapted to perform a desired operation in response to depression of one of these keys 48-52. For example, pressing the “cancel” key 48 causes the microprocessor 30 to immediately end a particular transaction operation. The “clear” key 50 prompts the microprocessor 32 to clear previously entered information. Finally, the “enter” key 52 confirms that certain entered information is correct.

The touch-screen display 34 is further preferably formatted to provide a signature-capturing feature. In particular, the touch-screen display 34 in conjunction with the microprocessor 30 is preferably adapted to designate a signature box (shown generally at 54 in FIG. 2A) at a desired time during a financial transaction procedure within which the customer 22 can write his/her signature, such as via an electronic pen 56. The so-entered signature is electronically stored in an analog or digital format by the microprocessor 30 such as in the RAM 38. Alternatively, other techniques for electronically storing a signature can be incorporated into the RCU 12.

The software used to control operation of the microprocessor 30 is stored in the ROM 40. Conversely, information entered via the touch-screen display 34, the keypad 36, and/or the magnetic card swipe reader 42 is stored by the microprocessor 30 in the RAM 38 for further processing. In particular, the microprocessor 30 formats the data and signals information via the IR transmitter 46.

The magnetic card swipe reader 42 reads and decodes information on a magnetic stripe provided by a financial card (not shown) otherwise swiped through the reader 42. The swipe reader 42 sends information to the decode logic module 44 that converts the serial bit stream from the reader 42 into a byte-wide stream for input to the microprocessor 30. Alternatively, other configurations for converting information provided by a financial card otherwise swiped (or dipped) through the reader 42 can be incorporated.

Finally, in one embodiment, the RCU 12 includes a printer module 58 that is otherwise connected to the microprocessor 30. As described in greater detail below, the microprocessor 30 is adapted to operate the printer module 58 to print a transaction receipt that in turn is provided to the customer 22 (FIG. 1) upon completion of a financial transaction.

In one preferred embodiment, the RCU 12 is a remote control unit available under the trade name “ICE 4000” from Hypercom Corp., of Phoenix, Ariz. Alternatively, other forms are equally acceptable.

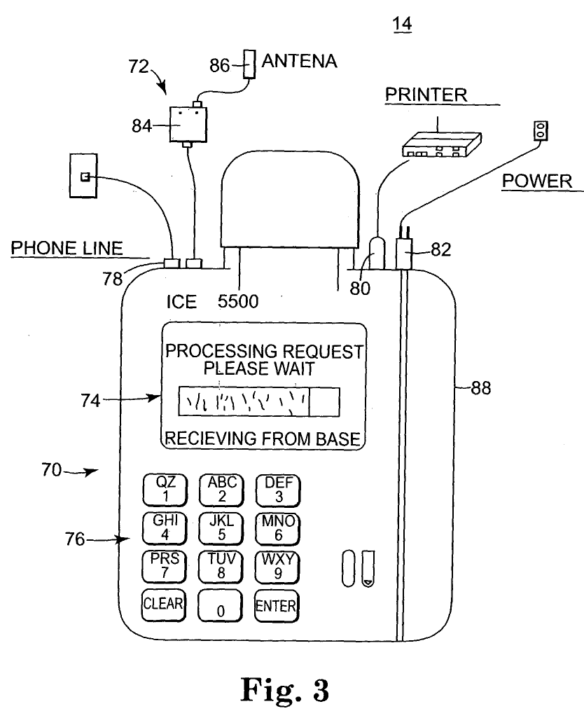

One preferred embodiment of the base processor module 14 is provided in FIG. 3. In this regard, the base processor module 14 preferably includes a base processor 70 and a wireless transmitting/receiving device 72. The base processor 70 is a microprocessor-based device, capable of storing information and performing desired operations. In one embodiment, the base processor 70 includes a display screen 74, a keypad 76, a phone line port 78, a printer port 80, and a power supply receptacle 82. In one preferred embodiment, the base processor 70 is a processor device available under the trade name “ICE 5500” from Hypercom Corp., of Phoenix, Ariz., although other configurations are equally acceptable. In a further preferred embodiment, the base processor 70 further includes, or has access to, a memory (not shown) in which customer information is stored in a designated database. As described below, this database can be periodically referenced to retrieve previously entered identification information for a repeat user of the system 10 (FIG. 1).

The display 74 is adapted to inform a user of a particular operational status, whereas the keypad 76 affords the ability to enter desired information.

The transmitting/receiving device 72 is adapted to transmit and receive wireless signaled information to and from the RCU 12 (FIG. 2A) for subsequent processing. In one embodiment, the transmitting/receiving device 72 includes a terminal transceiver 84 and an antenna 86. An appropriate terminal transceiver interface device is available from Hypercom Corp., of Phoenix, Ariz. Alternatively, the transmitting/receiving device 72 can be incorporated directly into a housing 88 otherwise provided by the base processor 70. Regardless, the transmitting/receiving device 72 is adapted to wirelessly transmit information to, and receive information from, the portable RCU 12.

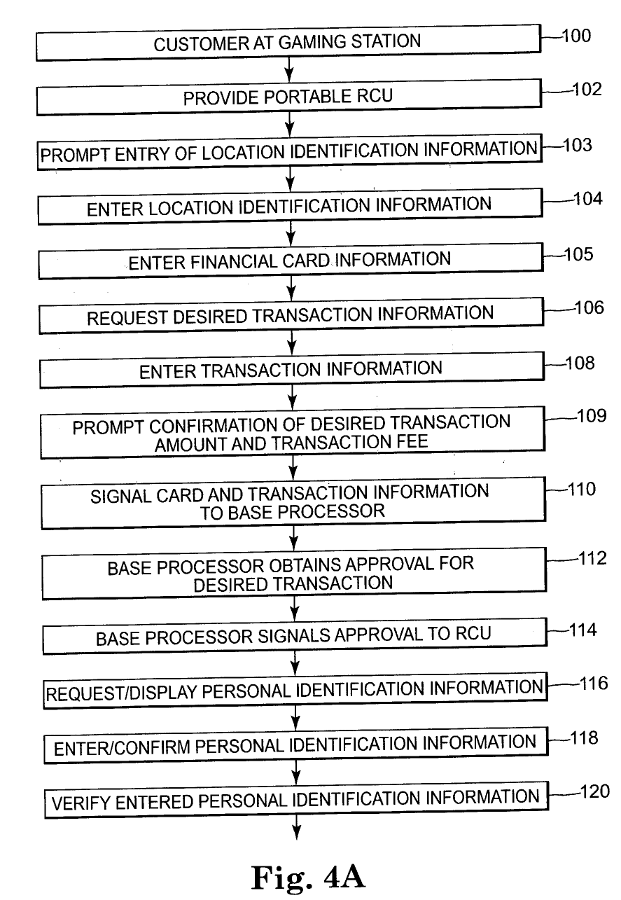

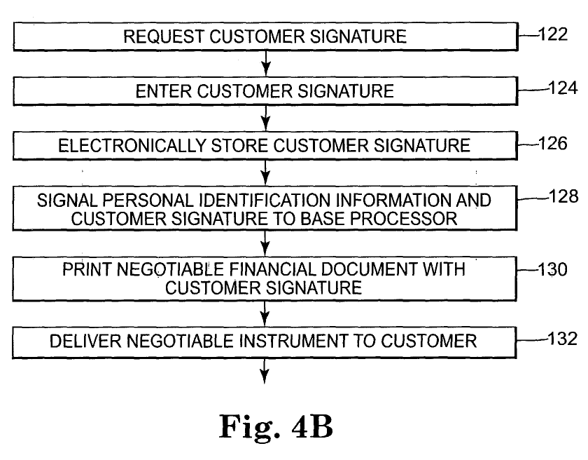

A preferred method of operating the system 10 in accordance with the present invention is provided in flow diagram form in FIGS. 4A and 4B. Beginning at step 100, the customer 22 is located at the gaming station 20 within the casino 18. Once again, the gaming station 20 can be one of many gaming activities typically found at a casino, such as a gaming machine (e.g., slot machine, a video poker machine, keno machine, etc.), or a gaming table (e.g., card table, roulette table, craps table, bingo table, etc.).

The customer 22 then desires to obtain cash or other negotiable instrument to continue playing at the gaming station 20. With this in mind, at step 102, the portable RCU 12 is provided to the customer 22 at the gaming station 20. For example, where the gaming station 20 is a card table, the portable RCU 12 can be located on the table itself, or can be stored within arm's reach of an attendant (e.g., dealer, pit boss, etc.) who then provides the portable RCU 12 to the customer 22. Alternatively, casino “runners” are normally dispersed throughout the casino 18 who constantly walk about the casino 18, and are available to assist customers. With this in mind, where the customer 22 is located at a discrete gaming station (e.g., slot machine, video poker, etc.), the runner or other casino personnel can hand deliver the portable RCU 12 to the customer 22. Regardless, the customer 22 is not required to exit or otherwise leave the gaming station 20 to access or interact with the portable RCU 12.

In one preferred embodiment, the RCU 12 then prompts the customer 22 (or casino attendant) to enter location identification information indicative of the particular casino location (or gaming station) at which the RCU 12 and the customer 22 are currently located at step 103. As described in greater detail below, documentation and/or a negotiable instrument may be delivered from a location of the base processor module 14 to the customer 22 upon completion of the financial transaction. To ensure that the document(s) and/or instrument is correctly delivered to the customer 22 (and not to a different customer using a separate RCU), an indication is preferably provided to the base processor module 14 (and thus a casino attendant otherwise responsible for delivering document(s)/instruments from the base processor module 14) of the casino location at which the financial transaction is being performed. The location identification information can assume a wide variety of forms, such as cashier number/designation, table number/designation, gaming machine number/designation, etc. Alternatively, the RCU 12 can be programmed to automatically provide pre-determined location identification information (e.g., where the RCU 12 is permanently located at a specific gaming table, the corresponding table number/designation information can be entered into, and saved by, the RCU 12). Where appropriate, the proper location identification information is entered at step 104. Alternatively, where identifying a specific location of the RCU 12 and/or the customer 22 is of little or no concern, steps 103 and 104 can be omitted.

The customer 22 enters information derived from a financial institution-issued card otherwise owned by the customer 22 at step 105. As is known, various financial institutions issue cards to their customers that include account information based upon which the customer can utilize to access funds otherwise maintained in that account. Examples of available financial institution cards include credit cards, debit cards, bank cards, etc. The account information can be manually entered by the customer 22 (and/or an attendant) via the touch-screen display 34, or by simply swiping (or dipping) the card through the magnetic card swipe reader 42 (FIG. 2A).

The RCU 12 then prompts the customer 22 to enter transaction information into the RCU 12 at step 106. In particular, the customer 22 is requested to enter a desired amount of the proposed financial transaction. At step 108, the customer 22 provides the transaction information to the RCU 12, such as by the touch-screen display 34.

In one preferred embodiment, the RCU 12 is adapted to determine a transaction fee to be paid by the customer 22 based upon the previously-entered desired amount (e.g., 7% of the desired amount). Alternatively, a predetermined “standard” transaction fee can be stored by the RCU 12 (e.g., $25). Regardless, the determined transaction fee is displayed to the customer in conjunction with the desired transaction amount at step 109, along with a request that the customer 22 confirm that the desired transaction amount is correct and that he or she agrees to pay the transaction fee (e.g., pressing a designated key on the RCU 12). Alternatively, the financial transaction of the present invention can be performed without a transaction fee.

The financial card information and transaction information (including the transaction fee where applicable) are signaled from the RCU 12 to the base processor module 14 via wireless transmission at step 110. In a preferred embodiment, the previously entered location identification information is also signaled from the RCU 12 to the base processor module 14, and in particular the transmitting/receiving device 72, at step 110. The base processor 70 is then operated to obtain approval for the desired financial transaction (including the transaction fee where applicable) from the financial institution that otherwise issued the particular financial card at step 112. For example, the base processor 70 can be connected (such as via a phone line) to a financial transaction processing service provider. One such service provider is Vital Processing Services of Tempe, Ariz. In general terms, the requested transaction amount (including the transaction fee where applicable) is either authorized or denied by the service, with this decision then being provided to the base processor 70. The base processor 70, in turn, signals (via the transmitting/receiving device 72) the approval or denial of the transaction request to the portable RCU 12 at step 114.

Assuming the requested transaction amount (including the transaction fee where applicable) has been approved, the portable RCU 12 then prompts the customer 22, at step 116, to enter personal identification information, such as the customer's 22 name, address, zip code, etc. In one preferred embodiment, the base processor module 14 maintains a personal identification database. In the event the customer 22 has previously performed a financial transaction through the system 10 (as indicated, for example, by previously processing a financial institution card matching the financial card information previously provided at step 104), the base processor module 14 can signal saved personal identification information to the RCU 12 that in turn displays it to the customer 22. The customer 22 need only confirm the accuracy of the displayed information. Regardless, at step 118, the requested information is entered (or confirmed or updated if necessary), either manually via the touch-screen 34 and/or the keypad 36, or by swiping an appropriate identification card (e.g., a driver's license formatted to include a magnetic strip). Regardless, and in one preferred embodiment, an attendant, at step 120, verifies the entered information.

At step 122, the RCU 12 prompts the customer 22 to enter his/her signature into the RCU 12. The customer 22 personally provides this signature at step 124. Once again, the customer 22 can enter his/her signature into the RCU 12 in a variety of fashions, but is preferably accomplished via the electronic pen 56 and the designated box 58 provided on the touch-screen display 34. Regardless, at step 126, the RCU 12 electronically captures and stores the entered signature. The RCU 12 then signals the identification information and the electronically captured signature to the base processor module 14 via a wireless transmission, as previously described, at step 128.

With the relevant identification and electronically captured signature information in hand, the base processor 70 is operated, at step 130, to print a negotiable financial document via the attached printer 16. The negotiable financial document can assume a variety of forms, such as a check or money order, but will include the customer's 22 signature (reproducing in ink on the printed document the electronically captured signature). In one preferred embodiment, the printed negotiable document is a financial note issued by a providers of the system 10, that, when cashed by the casino, is drawn upon the system provider's bank account. With this approach, the customer's signature is necessary to satisfy draft completion requirements set forth by most, if not all, financial institutions that issue financial cards. Thus, the customer's signature ensures that the system provider (or other third party provider) will not be held liable in the event the customer 22 later disputes the transaction.

The printed negotiable financial document will have a negotiable monetary value equivalent to a value of the desired financial transaction. In one preferred embodiment, where the financial transaction includes a transaction fee, the negotiable financial document will have a monetary value equal to the desired amount, along with a notation that the financial transaction fee has been charged against the customer's 22 designated account, with this transaction fee having been transferred to a separate designated financial account (e.g., the provider of the system 10) by the base processor module 14. Notably, this type of financial transaction processing is normally carried out through an automated clearing house (ACH) as is known in the art. In a further preferred embodiment, the printed negotiable financial document includes the previously provided location identification information for reasons described below.

Regardless of the exact content, once printed, the casino 18 can process the negotiable financial document in accordance with its internal procedures. In one preferred embodiment, multiple copies of the negotiable financial document are printed, with only one of the printed documents be validly negotiable. For example, the document can be printed in triplicate, with two of the three versions being denoted as “non-negotiable”. In any event, at step 132, a negotiable instrument is delivered to the customer 22 having a monetary value equal to the monetary value of the printed negotiable financial document. The negotiable instrument delivered to the customer can assume a variety of forms, and can include for example cash, chips, a separately prepared money order, or the previously printed financial document. Delivery of the negotiable instrument can take a variety of forms. For example, the attendant or runner (or other casino personnel) can review the approved information provided by the portable RCU 12 and provide the customer 22 with an amount of cash or chips equivalent to the approved amount or a casino-issued gaming card programmed to provide an account with the casino having a balance equivalent to the approved amount. Alternatively, an operator of the base processor module 14 can, after reviewing and processing the printed negotiable financial document, personally deliver, or direct another casino employee or other designee to deliver, chips, cash, or a casino-issued gaming card to the customer 22. In one preferred embodiment, the portable RCU 12 is further operated to print a transaction receipt that is given to the customer 22. In addition, or alternatively, a copy of the previously printed negotiable document is provided to the customer 22. In this regard, the location identification information, otherwise preferably printed on the document, provides a clear indication to the casino employee of where in the casino the document (and/or negotiable instrument) is to be delivered. This is especially useful in a casino having multiple RCUs 12 in operation.

The system and method of the present invention provides a marked improvement over previous designs. In particular, casino customers are able to conveniently obtain additional monetary funds via an off-site financial institution account without ever having to leave the gaming station at which the customer is located. The all-to-common frustration of prematurely terminating a gaming activity is avoided and casinos are better able to keep a customer engaged in a gaming activity.

What is claimed is:

1. A method of performing a financial transaction within a casino by a casino customer located at a casino gaming station, the method comprising:
providing a portable, remote control unit (RCU) to the casino customer at the casino gaming station;
entering transaction information into the RCU relating to a financial transaction desired by the customer from a customer account;
signaling the transaction information from the RCU to a base processor via wireless transmission;
operating the RCU to electronically capture a signature of the customer;
signaling the electronically captured signature from the RCU to the base processor via wireless transmission; and
operating the base processor to print, via a printer electronically connected to the base processor, a negotiable financial document based upon the transaction information, the negotiable financial document including the customer's signature generated by the base processor based upon the electronically captured signature.

2. The method of claim 1, wherein the method is characterized by the casino customer not leaving the casino gaming station.

3. The method of claim 1, wherein entering transaction information includes:
entering a monetary value desired by the casino customer.

4. The method of claim 3, further comprising:
operating the base processor to perform a transaction approval operation based upon the desired monetary value.

5. The method of claim 4, further comprising:
signaling results of the transaction approval operation from the base processor to the RCU via wireless transmission.

6. The method of claim 5, further comprising:
displaying the results of the transaction approval operation to the casino customer via the RCU.

7. The method of claim 3, further comprising:
determining a total transaction amount based upon the desired monetary value and a service fee; and
displaying the total transaction amount to the casino customer via the RCU.

8. The method of claim 7, further comprising:
operating the base processor to determine the total transaction amount; and
signaling the total transaction amount from the base processor to the RCU via wireless transmission.

9. The method of claim 7, further comprising:
prompting the casino customer to indicate acceptance of the total transaction amount via the RCU after the step of displaying the total transaction amount to the casino customer.

10. The method of claim 9, further comprising:
operating the base processor to electronically transfer funds equal to the service fee from the customer account after the step of prompting the casino customer to indicate acceptance.

11. The method of claim 7, wherein the printed negotiable financial document has a negotiable monetary value equal to the desired monetary value.

12. The method of claim 1, further comprising:
entering customer identification information into the RCU; and
signaling the customer identification information from the RCU to the base processor via wireless transmission;
wherein operating the base processor to print a negotiable financial document includes formatting the negotiable financial document to include printed identification information based upon the customer identification information.

13. The method of claim 1, further comprising:
delivering a negotiable instrument to the casino customer after the step of printing the negotiable financial document.

14. The method of claim 13, wherein the negotiable instrument has a monetary value equal to a monetary value of the negotiable financial document.

15. The method of claim 13, wherein the negotiable instrument is selected from the group consisting of currency, casino-issued chips, casino-issued gaming card, check, or the printed negotiable financial document.

16. The method of claim 13, further comprising:
operating the RCU to signal a location of the gaming station to the base processor prior to the step of delivering a negotiable instrument to the casino customer;
wherein delivery of the negotiable instrument is based upon the signaled location of the gaming station.

17. The method of claim 16, wherein operating the base processor to print the negotiable financial document includes printing indicia on the negotiable financial document indicative of the location of the gaming station.

18. The method of claim 1, wherein the base processor and the printer are located within the casino.

19. The method of claim 1, wherein the gaming station is selected from the group consisting of a gaming machine and a gaming table.

20. A system for performing a financial transaction within a casino by a casino customer located at a casino gaming station, the system comprising:
a remote controlled unit (RCU) deliverable to the gaming station, the RCU adapted to:
receive transaction information relating to a financial transaction desired by the casino customer from a customer account,
electronically capture a signature of the casino customer,
wirelessly signal the transaction information and the electronically captured signature;
a base processor adapted to:
receive wireless signals from the RCU,
generate negotiable financial document formatting information based upon the transaction information and the electronically captured signature; and
a printer electronically connected to the base processor for printing a negotiable financial document from the negotiable financial document formatting information, the printed negotiable financial document displaying the customer's signature.
